(19) United States
(12) Patent Application Publication
(10) Pub. No.: US 2006/0087254 A1
(43) Pub. Date: Apr. 27, 2006

(54) Multi-lamp tube controlling circuit

(75) Inventors: Hui-Chiang Yang, Hsintien City (TW); Yao-Chen Wang, Taipei City (TW)

Correspondence Address: TROXELL LAW OFFICE PLLC;SUITE 1404, 5205 LEESBURG PIKE, FALLS CHURCH, VA, 22041, US

(73) Assignee: Niko Semiconductor Co., Ltd.

(21) Appl. No.: 10/969,989

(22) Filed: Oct. 22, 2004

(51) Int. Cl. H05B 41/36

(52) U.S. Cl. 315/247; 315/276; 315/224; 315/308

(57) ABSTRACT

A multi-lamp tube controlling circuit includes at least one driving unit and having at least one switch individually, at least one transformer connected to the driving unit and the lamp, a current detection unit connected to the lamp for obtaining the loading current of the lamp, a pulse-width modulation (PWM) controlling unit connected to the current detection unit for obtaining the loading current so as to output a pulse-width modulation signal, at least one voltage detection unit connected to the lamp and the transformer for obtaining the loading voltage of the lamp, and a multi-lamp tube PWM controlling unit connected to the driving unit, the voltage detection unit, and the PWM controlling unit for receiving the pulse-width modulation signal and the loading voltage of the lamp for outputting a controlling signal to drive the switch for switching after processing the pulse-width modulation signal and the loading voltage.

### BACKGROUND OF THE INVENTION

1. Field of the Invention

The present invention relates to a multi-lamp tube controlling circuit, and more particularly, to a multi-lamp tube controlling circuit for driving at least one cold cathode fluorescent lamp (CCFL) tube and controlling the tube with respect to the voltage feedback of the tube.

2. Description of the Prior Art

Cold cathode fluorescent lamps have been known for their use as the light source of the backlight system in liquid crystal display (LCD) panels. A driving circuit of an inverter is used for driving this kind of fluorescent lamp. As the demand for larger panel sizes gradually increases, display panels with only one florescent lamp are more and more unlikely to catch up with the trend, necessitating two or more fluorescent lamps in a single display panel.

The power supply of the backlight source of the TFT panel generally comes from an inverter circuit transforming the direct current (DC) to the alternating current (AC) in order to drive the cold cathode fluorescent lamp to emit the light. The conventional inverter circuit is selected from a group consisting of a half-bridge inverter, a full-bridge inverter, and a push-pull inverter, in terms of topology.

Please refer to FIG. 1 of a schematic diagram showing a push-pull inverter circuit driving a multi-lamp circuit. The PWM controller U2 connects switches Q3 and Q4 for controlling operations (on and off) of these switches Q3 and Q4, transforming the direct current into the alternating current. The alternating current would become available to lamp tubes P1 and P2 connected to transformers T1 and T2 after passing through transformers T1, T2, T3 and T4.

The PWM controller U2 in FIG. 1 includes a voltage detection unit 82 consisting of diodes D3 and D6 and capacitors C2, C3, C5, C8, and C17 for obtaining loading voltages of lamp tubes P1 and P2. The voltage detection unit 82 at the same time transmits a voltage feedback signal to the PWM controller U2. The PWM controller U2 further includes a current detection unit 84 including diodes D1 and D5, capacitors C15 and C18, and the resistor R14 in order to obtain loading currents of tubes P1 and P2. The current detection unit 84 further returns a current feedback signal to the PWM controller U2. The PWM controller U2 outputs a driving signal controlling the operation of switches Q3 and Q4 on the basis of the voltage and current feedback signals, so as to adjust operating voltages and currents of lamp tubes P1 and P2, allowing tubes P1 and P2 to operate in a steady state.

All tubes are under the control of a PWM controller U2 controlling the periods of on and off for adjusting the brightness of pictures shown on the display panel. A large-size liquid crystal television may have 10 to 20 (or even more) lamp tubes and thus the occurrence of disability among these tubes increases accordingly. In the event that any lamp tube is out of work (unable to be turned on), the whole circuitry would be turned off in order to protect components thereof from damages of unusual high voltages. However, at this point no picture would be able to be shown on the display.

### SUMMARY OF THE INVENTION

It is therefore a primary objective of the present invention to provide a multi-lamp tube controlling circuit having at least one voltage detection unit for obtaining loading voltages of lamp tubes and transmitting these obtained loading voltages to a multi-lamp tube PWM controlling unit connected to a PWM controlling unit for receiving a pulse-width modulation signal outputted from the PWM controlling unit. The multi-lamp tube PWM controlling unit outputs at least one controlling signal to at least one driving unit after processing the loading voltages and the pulse-width modulation signal.

In accordance with the claimed invention, the present multi-lamp tube controlling circuit employs a multi-lamp tube PWM controlling unit connected to at least one driving unit, at least one voltage detection unit, and a PWM controlling unit. The multi-lamp tube PWM controlling unit receives the pulse-width modulation signals from the PWM controlling unit and the voltage detection unit obtains loading voltages of these lamp tubes. Thereafter at least one controlling signal is outputted to the driving unit so as to control operations of at least one switch in the driving unit. The driving unit therefore provides the power required to the lamp tubes through transformers with respect to a power source.

In accordance with another preferred embodiment, the present multi-lamp tube controlling circuit employs a multi-lamp tube PWM controlling unit connected to at least one driving unit, at least one voltage detection unit, and a PWM controlling unit. The PWM controlling unit outputs a first pulse-width modulation signal to the driving unit outputting a second pulse-width modulation signal to the multi-lamp tube PWM controlling unit. After receiving the second pulse-width modulation signal, the PWM controlling unit further obtains and processes loading voltages of these tubes through the voltage detection unit so as to output at least one controlling signal. The controlling signal and the first pulse-width modulation signal are transmitted to the driving unit for driving switches therein for switching.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing a multi-lamp tube circuit driven by a conventional push-pull inverter.

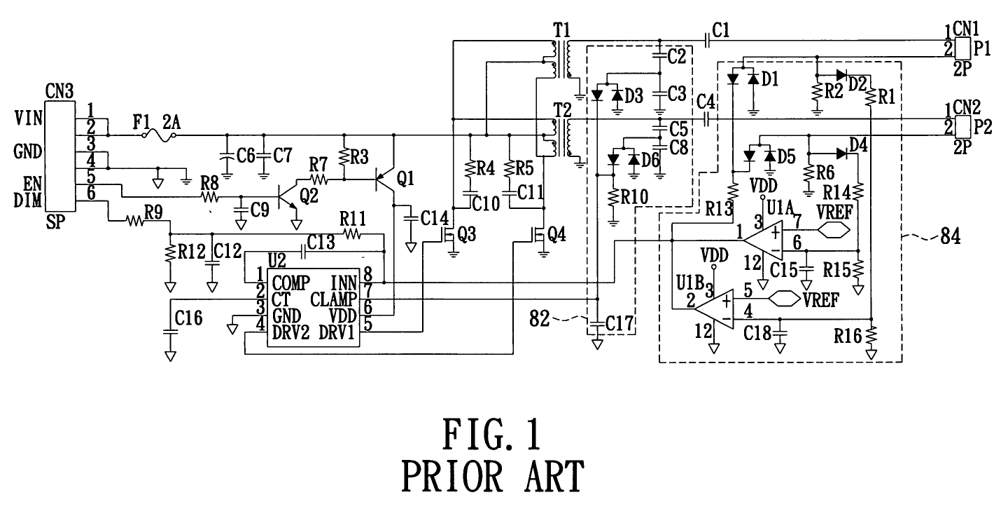

FIG. 2 is a block diagram showing a first preferred embodiment according to the present invention.

FIG. 3 is a schematic diagram showing a multi-lamp tube PWM controlling unit circuit used in the present invention.

FIG. 4 is a block diagram showing a second preferred embodiment according to the present invention.

### DETAILED DESCRIPTION OF THE PREFERRED EMBODIMENT

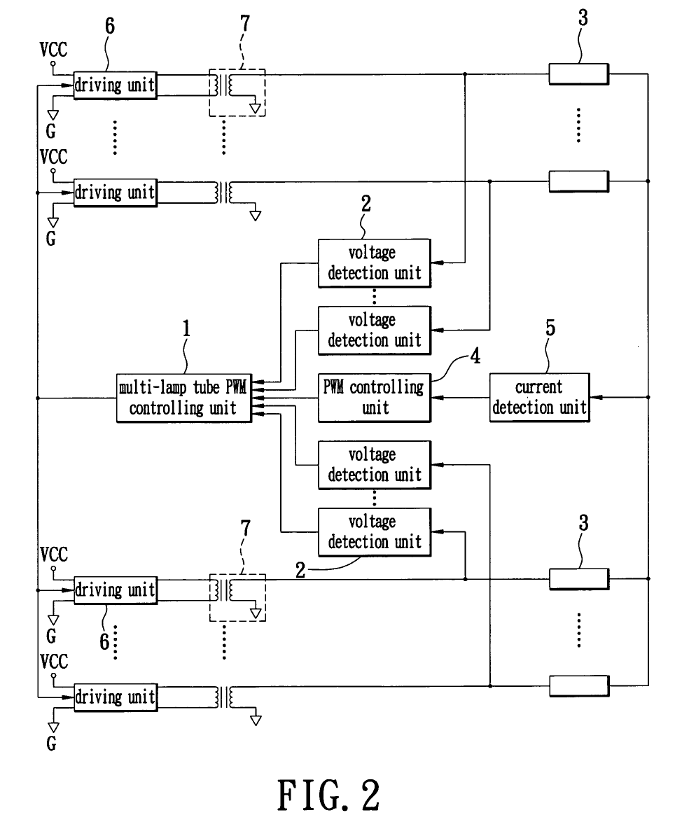

Please refer to FIG. 2 of a circuit block diagram showing the first embodiment according to the present invention. The present invention multi-lamp tube controlling circuit is connected to a power source VCC for driving at least one lamp tube 3 to emit light. The controlling circuit includes a multi-lamp tube PWM controlling unit 1, at least one voltage detection unit 2, a PWM controlling unit 4, a current detection unit 5, at least one driving unit 6, and at least one transformer 7.

The voltage detection unit 2 connects to the lamp tubes 3 and transformers 7 for obtaining the loading voltages of these lamp tubes 3. The current detection unit 5 connects to the lamp tubes 3 and the PWM controlling unit 4 for obtaining loading currents of these lamp tubes 3 and then transmitting loading currents to the PWM controlling unit 4. The PWM controlling unit 4 receives these loading currents in order to output a pulse-width modulation signal.

The multi-lamp tube PWM controlling unit 1 connects to the driving unit 6, the voltage detection unit 2 and the PWM controlling unit 4, for receiving the pulse-width modulation signal and loading voltages of tubes. After processing the pulse-width modulation signal and these loading voltages, the PWM controlling unit 1 outputs at least one controlling signal to the driving unit 6, in order to drive at least one switch (not shown) in the driving unit 6. The driving unit 6 provides the power required by these tubes 3 through the transformer 7 with respect to the power source VCC and the pulse-width modulation signal from the multi-lamp tube PWM controlling unit 1. The driving unit 6 is a half-bridge driving unit or a push-pull one. Switches consist of two N-channel field effect transistors or two P-channel field effect transistors.

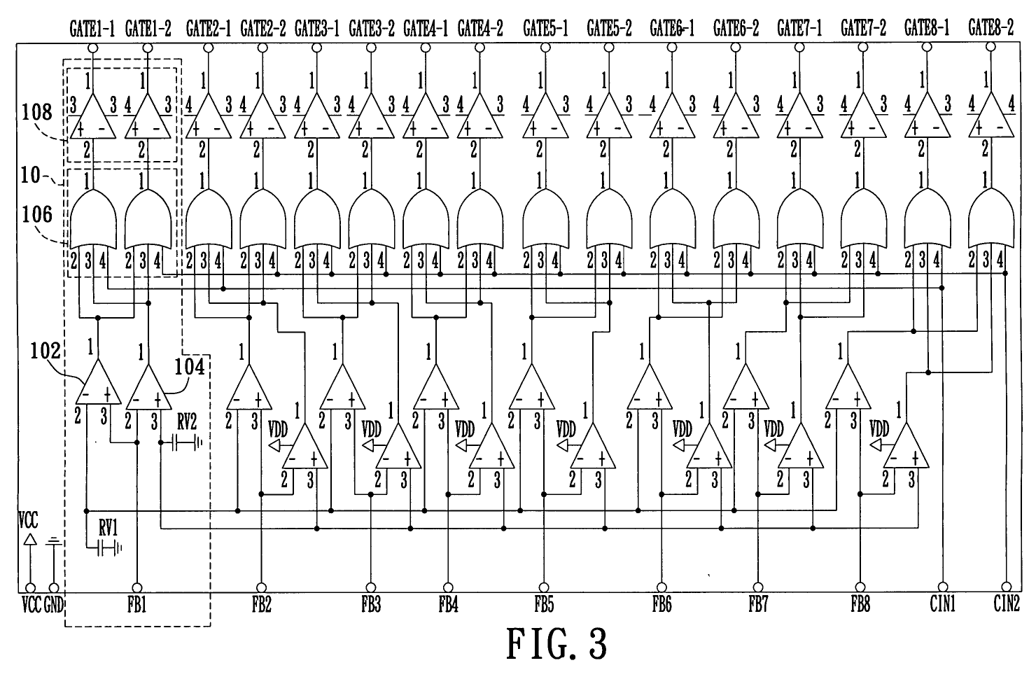

Please refer to FIG. 3 in conjunction with FIG. 2 showing a schematic diagram of the present invention multi-lamp tube PWM controlling unit circuit. The multi-lamp tube PWM controlling unit 1 includes at least one operation logic unit 10 connected with each other in a parallel manner. The operation logic units 10 receive loading voltages of the lamp tubes 3 through the voltage detection unit 2 and the pulse-width modulation signal outputted from the PWM controlling unit 4. After receiving and processing the loading voltages and the pulse-width modulation signal, the PWM controlling unit 1 outputs the controlling signal to the driving unit 6 for controlling operations of the switches (not shown).

The operation logic unit 10 includes a first comparator 102, a second comparator 104, a logic unit 106, and a driving device 108. The first comparator 102 connects to a first reference voltage RV1 and the voltage detection unit 2 for outputting a first comparison signal. The second comparator 104 connects to a second reference voltage RV2 and the voltage detection unit 2 for outputting a second comparison signal. The logic unit 106 connects to the first comparator 102, the second comparator 104, and the PWM controlling unit 4 so as to receive the first comparison signal, the second comparison signal and the pulse-width modulation signal and output the controlling signal through the driving device 108 to the driving unit 6 for driving at least one switch (not shown) in the driving unit 6. The driving unit 6 provides the power required for operation to tubes 3 through the transformer 7 with respect to the power source VCC and the pulse-width modulation signal of the multi-lamp tube PWM controlling unit 1.

The first and second reference voltages RV1 and RV2 have top and bottom voltage limits. The logic unit 106 is an or-gate logic unit. The voltage detection unit 2 obtains loading voltages of tubes 3 and transmits these loading voltages to the first and second comparators 102 and 104. The first and second comparators 102 and 104 compare loading voltages with the first and second reference voltages RV1 and RV2. If the loading voltages are between RV1 and RV2, the first and second comparators 102 and 104 output the first and second reference signals with “low” voltage levels to the logic unit 106 where an “OR” logic operation is performed. Then the controlling signal outputted from the logic unit 106 to the driving unit 6 is the pulse-width modulation signal outputted from the PWM controlling unit 4. In the event that loading voltages are between RV1 and RV2 indicative of no occurrence of out-of-work, the PWM controlling unit 4 outputs the pulse-width modulation signal to control operations of switches in the driving unit 6.

If one of the loading voltages of tubes 3 is higher than RV1 or lower than RV2, the first or second comparator 102 or 104 outputs the first or second comparison signal with a “high” voltage level to the logic unit 106 where another “OR” operation is performed. In this situation, the controlling signal outputted to the driving unit 6 from the logic unit 106 is a “disable” signal, turning off switches and stopping the provision of power to the tubes 3 which are out of work.

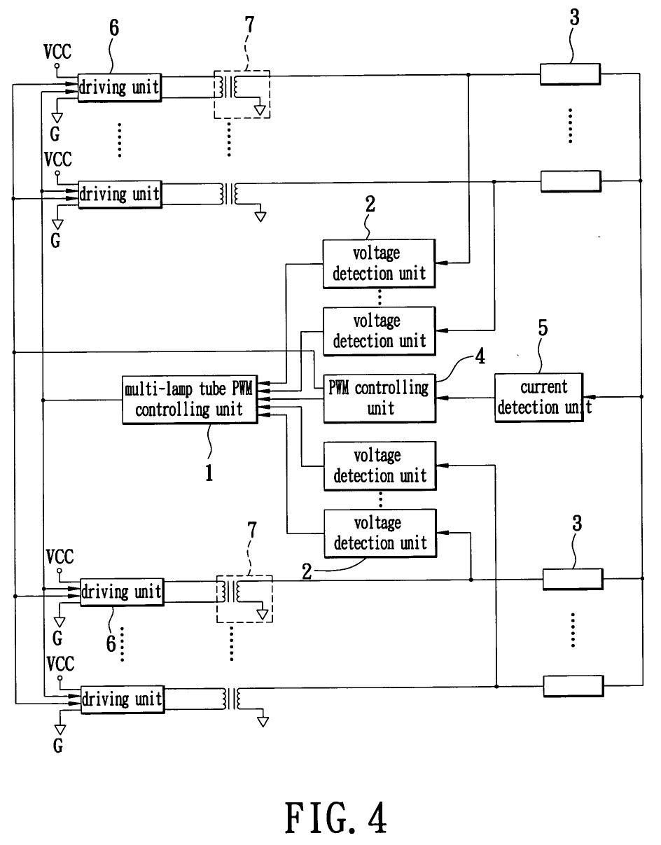

Please refer to FIG. 4 in conjunction with FIG. 2 for showing a circuit block diagram of a second embodiment according to the present invention. The driving unit 6 in this embodiment is a full-bridge one forming the primary difference between this embodiment and the previous preferred embodiment. Additionally, switches in the driving unit 6 consist of N-channel field effect transistors, P-channel field effect transistors, or the hybrid of N-channel and P=channel field effect transistors. The PWM controlling unit 4 connects to the driving unit 6 and the multi-lamp tube PWM controlling unit 1, for transmitting the first pulse-width modulation signal to the driving unit 6 and the second pulse-width modulation signal to the multi-lamp tube PWM controlling unit 1. The multi-lamp tube PWM controlling unit 1 connects to the driving unit 6, the voltage detection unit 2, and the PWM controlling unit 4, for receiving and processing the second pulse-width modulation signal and loading voltages so as to output at least one controlling signal to the driving unit 6. The driving unit 6 receives the first pulse-width modulation signal and the controlling signal in order to drive switches (not shown).

While loading voltages of tubes 3 are between the first and second reference voltages RV1 and RV2, the controlling signal outputted to the driving unit 6 from the logic unit 106 is the second pulse-width modulation signal outputted from the PWM controlling unit 4. Under this circumstance, the PWM controlling unit 4 outputs the first and second pulse-width modulation signals to control operations of switches in the driving unit 6.

In the case that one of loading voltages of tubes 3 is higher than RV1 or lower than RV2 indicative of the occurrence of out-of-work tubes, the controlling signal outputted to the driving unit 6 from the logic unit 106 is a “disable” signal for turning off switches and thus stopping the power further provided to the out-of-work tubes 3.

The present invention multi-lamp tube controlling circuit employs at least one voltage detection unit 2 for obtaining loading voltages of these lamp tubes 3, and the multi-lamp tube PWM controlling unit for receiving these loading voltages of tubes 3 and the pulse-width modulation signal from the PWM controlling unit. Thereafter, at least one controlling signal is outputted to the driving unit 6 so as to allow the driving unit 6 to provide the power required to the tubes 3 through the transformer 7.

At the time the loading voltage of one given lamp tube is unusual (larger than RV1 or lower than RV2), the loading voltage of the lamp tube 3 obtained by the voltage detection unit 2 would be compared on the part of the multi-lamp tube PWM controlling unit 1, and then a disable signal would be outputted to the driving unit 6 for turning off switches so as to further stop the power provided to the out-of-work lamp tube 3.

Once any given lamp tube 3 is out of work, the lamp tube 3 would be turned off immediately, not affecting other tubes which are still working. In a multi-lamp tube display panel, human eyes could not tell the difference while one or two lamp tubes are out-of work because generally speaking no ordinary user adjusts the brightness of the display panel to its maximum (upper limit or 100%). Therefore if users are not comfortable with the brightness of display panels, they usually adjust the brightness of other working tubes a little bit higher and no recall is necessary. Consequently, the present invention can significantly reduce the number of recall, saving a chunk of maintenance costs and labors.

In contrast to the prior art, the present invention simply turns off out-of-work tubes rather than turning the whole display off.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A multi-lamp tube controlling circuit connected to a power source for driving at least one lamp to emit the light, comprising:
at least one driving unit connected to the power source and having at least one switch individually;
at least one transformer connected to the driving unit and the lamp;
a current detection unit connected to the lamp for obtaining the loading current of the lamp;
a pulse-width modulation (PWM) controlling unit connected to the current detection unit for obtaining the loading current so as to output a pulse-width modulation signal;
at least one voltage detection unit connected to the lamp and the transformer for obtaining the loading voltage of the lamp; and
a multi-lamp tube PWM controlling unit connected to the driving unit, the voltage detection unit, and the PWM controlling unit for receiving the pulse-width modulation signal and the loading voltage of the lamp for outputting a controlling signal to drive the switch for switching after processing the pulse-width modulation signal and the loading voltage.

2. The controlling circuit in claim 1 wherein the driving unit is a half-bridge driving unit.

3. The controlling circuit in claim 1 wherein the driving unit is a push-pull driving unit.

4. The controlling circuit in claim 1 wherein the switch is a N-channel field effect transistor (FET).

5. The controlling circuit in claim 1 wherein the switch is a P-channel field effect transistor (FET).

6. The controlling circuit in claim 1 wherein the multi-lamp tube PWM controlling unit comprises at least one logic operation unit connected with each other in a parallel manner wherein the logic operation unit receives and processes the loading voltage and the pulse-width modulation signal and then outputs the controlling signal to the driving unit in order to drive the switch.

7. The controlling circuit in claim 6 wherein the logic operation unit comprises a first comparator connected to a first reference voltage and the voltage detection unit so as to output a first comparison signal, a second comparator connected to a second reference voltage and the voltage detection unit so as to output a second comparison signal, and a logic unit connected to the first comparator, the second comparator, the PWM controlling unit, and the driving unit for receiving the first comparison signal, the second comparison signal, and the pulse-width modulation signal and outputting the controlling signal through a driving device.

8. A multi-lamp tube controlling circuit connected to a power source for driving at least one lamp to emit the light, comprising:
at least one driving unit connected to the power source and having at least one switch individually;
at least one transformer connected to the driving unit and the lamp;
a current detection unit connected to the lamp for obtaining the loading current of the lamp;
a pulse-width modulation (PWM) controlling unit connected to the current detection unit and the transformer for obtaining the loading current so as to output a first pulse-width modulation signal and a second pulse-width modulation signal and transmit the first pulse-width modulation signal to the driving unit;
at least one voltage detection unit connected to the lamp and the transformer for obtaining the loading voltage of the lamp; and
a multi-lamp tube PWM controlling unit connected to the driving unit, the voltage detection unit, and the PWM controlling unit for receiving and processing the second pulse-width modulation signal and the loading voltage of the lamp so as to output at least one controlling signal to drive the switch for switching.

9. The controlling circuit in claim 8 wherein the driving unit is a full-bridge driving unit.

10. The controlling circuit in claim 8 wherein the switch is a N-channel field effect transistor (FET).

11. The controlling circuit in claim 8 wherein the switch is a P-channel field effect transistor.

12. The controlling circuit in claim 8 wherein the switch consists of a N-channel FET and a P-channel FET.

13. The controlling circuit in claim 8 wherein the multi-lamp tube PWM controlling unit comprises at least one operation logic unit connected with each other in a parallel manner wherein the operation logic unit receives and processes the loading voltage of the lamp and the second pulse-width modulation signal and then outputs the controlling signal to the driving unit so as to drive the switch for switching.

14. The controlling circuit in claim 6 wherein the logic operation unit comprises a first comparator connected to a first reference voltage and the voltage detection unit so as to output a first comparison signal, a second comparator connected to a second reference voltage and the voltage detection unit so as to output a second comparison signal, and a logic unit connected to the first comparator, the second comparator, the PWM controlling unit, and the driving unit for receiving the first comparison signal, the second comparison signal, and the pulse-width modulation signal and outputting the controlling signal through a driving device.

15. A multi-lamp tube PWM controlling unit for a multi-lamp tube controlling circuit, the multi-lamp tube controlling unit connecting to a PWM controlling unit so as to drive at least one lamp to emit the light, comprising:
at least one first comparator having two inputting ends connected to a first reference voltage and a loading voltage of the lamp, respectively, for outputting at least one first comparison signal;
at least one second comparator having two inputting ends connected to a second reference voltage and a loading voltage of the lamp, respectively, for outputting at least one second comparison signal; and
at least one logic connected to the first comparator, the second comparator, and the PWM controlling unit, for receiving the first comparison signal, the second comparison signal, and a pulse-width modulation signal outputted from the PWM controlling unit and outputting at least one controlling signal through a driving device.
